(19) United States
(12) Patent Application Publication
(10) Pub. No.: US 2007/0088611 A1
(43) Pub. Date: Apr. 19, 2007

(54) Effecting ancillary actions on a transaction network

(76) Inventor: Brian David Christiansen, Singapore (SG)

Correspondence Address: GOTTLIEB RACKMAN & REISMAN PC, 270 MADISON AVENUE, 8TH FLOOR, NEW YORK, NY, 100160601, US

(21) Appl. No.: 11/127,053

(22) Filed: May 11, 2005

(51) Int. Cl. G06Q 20/00

(52) U.S. Cl. 705/16

(57) ABSTRACT

This invention generally relates to a method, system, apparatus and/or computer instruction code for operating a POS network and in particular relates to of the operation of a POS network to increase the functionality thereof.

### FIELD OF THE INVENTION

This invention generally relates to a method, system, apparatus and/or computer instruction code for operating a POS network and in particular relates to of the operation of a POS network to increase the functionality thereof.

### BACKGROUND TO THE INVENTION

The number of electronic transactions, such as those carried out on a point of sale (POS) network, has significantly increased in recent years. Many consumers regard the ability to electronically transfer funds from their own account to that of a merchant or service provider as highly convenient as it reduces the requirement to carry -cash or other alternative forms of currency. Using a POS network is convenient as there are many POS access points available to consumers in locations such as supermarkets, department stores and service stations, allowing consumers continuous 24 hour access to transfer and withdraw funds and/or use funds residing in an account to purchase goods or services from a merchant.

The POS network process provides quick and efficient on-line transfers of information that occur in real time. Therefore, it is not possible for a consumer to transfer (or withdraw) more funds than are available in an account,

Although debiting, transferring and withdrawing funds from an account is generally supported by POS networks, they do not currently support other actions that are also considered useful. For example, crediting an account is not supported and this must be done at a local access point of the entity that established and operates the account, such as a bank, or an affiliated bank or financial institution. Currently, the only form of credit which may be performed at POS access points is a refund of a purchase transaction. Further, refunds may only occur where a consumer has already performed a transaction with a particular merchant and, it is only that particular merchant who is able to issue the refund to credit a consumer's account.

While it is not currently possible to credit an account without performing a refund action, an account crediting standard for POS networks has been devised. However, before the standard can be implemented for crediting an account at a merchant POS, the software used to operate the POS system must be upgraded. As the number of POS access points and terminals is large, the cost to upgrade each of the servers associated with the access points and all the terminals is correspondingly large, and as a result, an upgrade of the POS network to allow account crediting has not occurred. The cost associated with upgrading an entire transaction network is further complicated by the various ownership arrangements of the merchant terminals which may be leased or owned outright by a merchant. The existing functionality of merchant terminals and a transaction network is governed by the Global Card Associations who also determine the identification number appearing on cards issued by a financial institution to a user. Manufacturers of merchant terminals adhere to the parameters set by the Global Card Associations when manufacturing and programming merchant terminals. Any change to the-existing set of programmed functions of merchant terminals would require a software upgrade to all merchant terminals and accordingly, any proposed change would need to be evaluated, tested and approved by the various manufacturers of merchant terminals to ensure that any change implemented by the Global Card Associations could be properly effected by the installed base of merchant terminals.

Accordingly, it is an object of the present invention to provide a system, method, apparatus and/or computer instruction code to increase the range of actions able to be effected by a POS network whilst avoiding the requirement to alter existing network components located at the merchant premises or the merchant's bank that are usually involved with POS transactions. In this respect, it is an object of the invention to enable POS networks to effect ancillary actions, namely, those actions not presently supported by POS networks, and to effect those actions using presently installed software and apparatus at the merchant's premises and the merchant's banks.

Whilst the agreed POS standard may include provision for a range of actions, those that are presently accepted as being the standard set of available actions that can be relied upon only include the actions of processing a purchase payment, reversal of a prior payment and authorisation of a transaction (ie PIN verification).

Any discussion of documents, devices, acts or knowledge in this specification is included to explain the context of the invention. It should not be taken as an admission that any of the material formed part of the prior art base or the common general knowledge in the relevant art on or before the priority date of the claims herein.

### SUMMARY OF THE INVENTION

The Method of the Invention

According to one aspect, the present invention provides a method of operating a POS network to perform ancillary actions, the method including the steps of:

collecting account information associated with a user at a POS network access point;

verifying said account information;

entering data at the POS network access point that has a predetermined ancillary action associated with that data;

transmitting a POS packet from the network access point to a processing intermediary with the data representing the ancillary action embedded within said packet;

the processing intermediary receiving said POS packet, identifying said data and causing a transmission to a predetermined server for effecting said ancillary action; and

the predetermined server effecting said ancillary action with respect to the verified account.

Advantageously, the ancillary action performed with respect to the account may be effected through the use of an existing POS network, without requiring costly modifications to the hardware or software that forms the existing POS network of the merchant location or the merchant's bank. Preferably, the data that is entered at the POS network access point is data that could normally be included in a POS transaction such that any pre-existing POS transaction apparatus or devices could process the POS packet. In this respect, whilst a processing intermediary may recognise a data value as representing an ancillary action, processing of the POS packet should not cause any problem when processed by any other apparatus or devices forming part of an existing POS network.

As a result, particular data and/or data values when appearing in a POS packet effectively represent a class of transaction that relates to ancillary actions. Processing intermediaries are provided with computer instruction code that embodies details of the data and/or data values and correlate same with predetermined ancillary actions.

In a preferred embodiment, upon recognising a POS packet as representing a request for an ancillary action, the processing intermediary intercepts and redirects the packet thus preventing same from being transmitted to its usual destination across the POS network. In an alternative embodiment, the processing intermediary effectively monitors the passage of POS packets as they pass through to their usual destination and upon recognising a request for an ancillary action, generates a data packet for transmission to a predetermined server for effecting the ancillary action. The ancillary -action performed may include adding funds to an account, activating an account or deactivating an account and in a particularly preferred embodiment, monetary values that are not typically used in existing transactions over such networks are selected to correspond with particular ancillary actions to be performed. Alternatively, other data fields such as the “Clerk Code” field or the user PIN No. field in a POS packet that are not typically used in transactions could be used to signify a request for an ancillary action and identify the particular ancillary action required.

The step of collecting account information associated with a user may be performed by the user presenting a user device such as a card including a magnetic strip and inserting same into a POS access point. The account information may then be read from the card and transmitted across the network for verification. Alternatively, the user device may include a barcode which may be scanned to collect account information or any other suitable storage device such as an RFID device, a biometric chip card or a suitably configured mobile phone or personal digital assistant.

Verifying account information may include correlating the account number stored on the magnetic strip of the card, or the barcode of the card, with an account number held on an account server. The step may further include the user entering a personal identification number (PIN). The use of a PIN advantageously provides a level of security with respect to transactions performed at a POS access point.

Preferably, if a monetary value is used to signify and identify an ancillary action, the choice of monetary value will be a value that is typically not used in existing POS transactions such as an amount less than one dollar, for example one cent or one penny.

In an alternative embodiment, another typically unused data field in a POS packet, such as the clerk code, is used to signify and identify an ancillary action. In a particularly preferred embodiment, various data fields within a POS packet may be used to signify and identify ancillary action requests depending upon fields that are typically unused, In this instance, one particular network may not typically use the clerk code field whereas another network may use this field on a regular basis. To accommodate the requirements of different networks or different circumstances, the processing intermediary that receives the POS packet may discern the request for an ancillary action from a range of data fields within a POS packet. Alternatively, a request for an ancillary action may make use of more than one data field, for example, the clerk code could indicate the type of ancillary action and another field could be used to indicate the amount.

In a preferred embodiment, ancillary actions are only made available to customers by a predefined set of merchants, effectively forming a “closed” environment within which ancillary actions may be effected, the merchants being familiar with the entry of the necessary data at a POS network access point that will signify and identify particular ancillary actions, In this embodiment, only the predefined set of merchants would be capable of effecting the required ancillary actions for consumers and the processing intermediary would not only examine the relevant data field in a POS packet to determine the requested ancillary action but would also examine whether or not the requested ancillary action was issued by a merchant from the predefined set of merchants authorised to request the particular ancillary action.

Further, in this particular embodiment, the processing intermediary may also examine the identification number of the user's device as contained in a POS packet and correlate same with the issuing entity and redirect the POS packet to the entities host for further processing and effecting the requested ancillary action.

By only allowing certain predefined merchants to effect a particular ancillary action, it is possible to ensure that all participating merchants are adequately trained and understand the method by which ancillary actions are requested. Further, by adopting this approach, it is also possible to ensure that all participating merchants able to effect certain types of ancillary actions have entered into the appropriate contractual arrangements detailing various liability issues and the agreed process that would be implemented in the event that a dispute arose between a merchant and/or the merchant's bank and the issuing entities bank. Any dispute regarding the settlement of amounts caused by issuing a request for ancillary actions will at least be able to be resolved in accordance with prior agreements.

When effecting ancillary actions within a closed environment, only those merchants within the predefined set of merchants will be relevant to the requested ancillary action. For example, in the event that a card holder increases the value of their account, it would only be possible to make purchases that draw value from the cardholder's account with another participating merchant within the closed environment. In one embodiment of the invention, it is expected that a closed environment would not include an automated cash dispensing apparatus and as such, once the value of a cardholder's account is increased by the supply of cash to a participating merchant, it would no longer be possible for the card holder to withdraw a cash equivalent value from their account. In this particular embodiment, a cardholder is restricted to redeeming the value of their account by purchasing goods and/or services from one or more merchants within the closed environment.

In a particularly preferred embodiment, the predefined set of merchants display a private label logo and customer cards that enable customers to effect ancillary actions within the closed environment of the predefined set of merchants also display the private label logo. In this embodiment, customers holding a customer card with the private label logo applicable to the closed environment would only approach merchants displaying the private label logo thus indicating the acceptance of this particular type of customer card. Further, upon presenting a customer card to a merchant within the closed environment, the merchant processes the customer card at their terminal which ensures that the BIN (Bank Institution No.) corresponds with a BIN that is accepted by the merchant's terminal. In the event that the merchant terminal does not accept the particular type of card offered by the customer, an indication will be provided to the merchant by the terminal to indicate that the customer card will not be processed by the terminal. However, upon a customer presenting a card that will be processed by the merchant's terminal, the request for an ancillary action is transmitted to a processing intermediary -that is programmed to analyse the transaction containing the request for an ancillary action and upon identifying such a request, the processing intermediary diverts the transaction to a predetermined server for effecting the requested ancillary action. This embodiment of the invention is particularly advantageous as it allows for the formation of a subset of merchants within an existing. POS network of merchants. Further, any predefined subset of merchants within a POS network of merchants may be the only merchants able to provide ancillary actions to consumers.

In an alternative embodiment, ancillary actions are made available to customers by any merchant, effectively forming an “open” environment in which ancillary actions may be effected. In this embodiment, any merchant will be capable of effecting the required ancillary action for a consumer and further, in the event a consumer has increased the value of their account at a participating merchant, they could subsequently withdraw a cash equivalent value from their account from an automated cash dispensing apparatus connected to the POS network.

Preferably, ancillary actions performed with respect to a user's account are performed in real time irrespective of whether they are executed in an “open” or “closed” environment.

Advantageously, the above described method does not prohibit a user device from acting as a normal debit or stored value device. The user's account may be accessed by the same user device to withdraw cash from an automatic teller machine (ATM) or from a merchant at a POS access point. The user may also use the same user device to make purchases of goods and services whereby the funds are transferred from the user's account to the merchant or service providers account in real time,

In addition to acting as a normal debit or stored value device, the user device may also be used to access services provided by organisations other than banks. These services may include accessing the internet, via an internet café or network access point whereby the cost of the access is deducted from the account, adding value to a prepaid mobile telephone or cell phone (also known as recharging), placing telephone calls or bill and invoice payments made via the Internet, via the telephone, via SMS,MMS or at interactive payment kiosks.

In an alternative embodiment, ancillary actions are effected by the use of a user device that cannot request any action other than an ancillary action, This embodiment is particularly advantageous in that it addresses the significant concern that in operation, the requesting and effecting of ancillary actions could involve a significant degree of human error. For example, where a single user device is used to effect usual transactions in addition to ancillary actions, there is a significant potential for human error on the part of a merchant processing a user's request with respect to an ancillary action In particular, where a merchant is required to enter a monetary value to indicate an ancillary action and subsequently enter additional data to indicate the monetary amount to be associated with the ancillary action, it is considered likely that human error may result in a monetary amount being incorrectly entered in place of the monetary value to request the ancillary action and as result, it is foreseeable that where a consumer considers that they have requested the addition of funds to an account by a specific monetary amount, a merchant could mistakenly process the transaction and effectively debit the consumer's account by the monetary amount. Further complicating the transaction would be the fact that the merchant would also receive from the consumer the monetary amount that the consumer intended to be credited to their account. In the event that such an error were to occur during a transaction between a consumer and a merchant, it would result in significant embarrassment on the part of the merchant and significant inconvenience on the part of the consumer. Further, in order to rectify this type of error, both the merchant and the consumer would be required to expend additional time and effort to retract the incorrect transaction and effectively re-enact the originally intended transaction. It is considered that the use of a user device that cannot request any action other than an ancillary action should significantly reduce the possibility of human error that could otherwise result in the above described scenario. Having separate user devices for requesting ancillary actions and subsequently indicating the monetary amount to be associated with the action over a transaction network should significantly reduce human error.

In one embodiment the user device is a swipe card and the BIN of the card is used to indicate that the device is only operable to request an ancillary action and/or the preferred routing of any resulting POS packet to an ancillary action server.

As usual, settlement preferably occurs at the end of each day with respect to the merchants providing POS access points and the banking systems connected to the POS network that have retained account balances in real time as a result of transactions occurring throughout the day. Daily settlement may also involve the payment of fees to various merchants and intermediaries that have enabled a POS network to perform and settle any actions.

An Apparatus of the Invention

According to another aspect, the present invention provides a server which, in use, is operably connected to a POS network, said server including:

receiving means for receiving information relating to a user provided by a POS access point, said information including at least information identifying the user by an account associated with the user;

verifying means for verifying the information received;

a data receiving means for receiving data entered at the POS access point and a transmission means for transmitting a POS packet including the data that has a predetermined ancillary action associated with that data;

a comparison means to determine whether the POS packet received represents a request for a predetermined ancillary action; and

processing means for effecting said ancillary action with respect to the verified account in the event that the received POS packet includes data representing a predetermined ancillary action.

The receiving means and verifying means are preferably implemented as electronic processing devices operably connected to the POS network such that upon receipt of information including at least information identifying the user and an account associated with the user, the information is passed to the verifying means that subsequently transmits a request over the POS network to another connected device that can compare the user information and the account information for verification. Further, the verifying means preferably receives confirmation or otherwise from a device operably connected to the POS network and provides the confirmation or otherwise to the server.

In a preferred embodiment, the data receiving means and the comparison means are also implemented as electronic processing devices within the server and receive the data entered at the POS access point and perform a comparison to determine whether that data represents a predetermined ancillary action. Predetermined ancillary actions and their corresponding data values are preferably stored in electronic memory within the server for relatively easy interrogation by the comparison means. Additionally, the processing means is preferably implemented as an electronic processing means for effecting any valid ancillary action requested with respect to a verified account.

A POS Network Implementing the Method of the Invention.

According to another aspect, the present invention provides a POS network when used for effecting ancillary actions, said POS network executing the following method steps:

collecting account information associated with a user at a POS access point;

verifying said account information;

transmitting data from the POS access point to a transaction processor said data representing a predetermined ancillary action; and

the transaction processor effecting said ancillary action with respect to the verified account.

A POS Network According to the Invention

According to a further aspect, the present invention provides a POS network including:

account information collection means at a POS access point for collecting account information associated with a user;

verifying means for verifying said account information;

a data entry means at the POS access point for entering data that represents a predetermined ancillary action; and

transmission means for transmitting the data to a transaction processor that effects ancillary actions with respect to verified accounts in accordance with the ancillary actions corresponding to the data transmitted.

In a preferred embodiment, the account information collection means is a POS magnetic strip reader of one of the types currently installed at POS access points. Further, the verifying means is preferably an electronic processing device operably connected to the POS network and operable to receive a request from a merchant's POS access point for verification of a user and the associated account information collected from a user's device.

In the embodiment where the account information collection means is one of the types of POS magnetic strip card readers, the data entry means is implemented as part of one of those devices that are operable for receiving data entry from a user and/or merchant. In particular, the data entry means is operable to receive data representing a predetermined ancillary action and similarly, the transmission means is preferably an electronic processing device contained within a POS magnetic card reader of one of the types currently used in POS networks, the transmission means operable to transmit the data entered by a user and/or merchant to a transaction processor that is preferably connected to the POS network and operable to effect actions with respect to verified accounts by having access to information pertaining to those accounts.

Computer Software Program Code for Implementing the Method of the Invention

According to a further aspect, the present invention provides a computer program embodied on a computer readable medium for effecting ancillary actions with respect to a user's account the computer program including:

computer instruction code for receiving account information associated with a user's account transmitted from a POS access point;

computer instruction code for verifying said account information;

computer instruction code for receiving a POS packet transmitted from the POS access point, said POS packet including data representing an ancillary action;

computer instruction code for determining whether any data received in the POS packet corresponds with a predetermined ancillary action; and

in the event that any data has an associated ancillary action, computer instruction code for effecting that ancillary action with respect to the verified account.

Preferably, computer instruction code operating on a device connected to the network generates an authorisation code in the event that a user's account is verified and causes the transmission of the authorisation code to the merchant to notify the merchant of the verification of the user's account and/or an approval to effect a transaction with respect to a user's verified account.

The code may result in computer instructions that are implemented integrally to a computer or of a network of computers using separate software components. The code may also include components of existing software that effect functions in cooperation with dedicated code developed specifically for the present invention.

Method of the Invention—POS Local Access Point

According to yet another aspect, the present invention provides a method of effecting ancillary actions with respect to a user account including the steps of:

the user providing account information associated with the user at a POS access point and transmitting same across the POS network for verification;

entering data at the POS access point, said data representing an ancillary action to be performed on the users account; and

receiving information transmitted across the POS network confirming whether said ancillary action has been effected with respect to the user's account,

Method of the Invention—Transaction Processor

According to a final aspect, the present invention provides a method of effecting ancillary actions with respect to a user's account including the steps of:

receiving account information associated with a user from a POS access point;

verifying said account information;

receiving data from said POS access point and determining whether the data represents an ancillary action; and

in the event that the data represents an ancillary action, effecting said ancillary action with respect to the verified account.

### BRIEF DESCRIPTION OF THE DRAWINGS

A preferred embodiment of the invention is now described with reference to the accompanying drawings in which the system and apparatus for effecting ancillary actions in a POS network is illustrated. It is to be understood that the system and apparatus of the present invention is not limited to the preferred embodiment illustrated in the drawings, in which:

FIG. 1 is a flow chart representing the primary method steps that are effected presently over a POS network for the purpose of a cardholder purchasing goods and/or services from a merchant;

FIG. 2 is a flow chart detailing the primary method steps presently effected for the purpose of clearing and settling the transactions between various parties as a result of a cardholder purchasing goods and/or services from a merchant;

FIG. 3 is a flow chart of the method steps effected in a preferred embodiment of the invention for the purpose of a cardholder effecting an ancillary action over a POS network;

FIG. 4 is a diagrammatic representation of a POS network for effecting predetermined ancillary actions; and

FIG. 5 is a further diagrammatic representation of a POS network for effecting predetermined ancillary actions showing additional detail in relation to POS access points and Electronic Funds Transfer (EFT) access points.

### DETAILED DESCRIPTION OF A PREFERRED EMBODIMENT

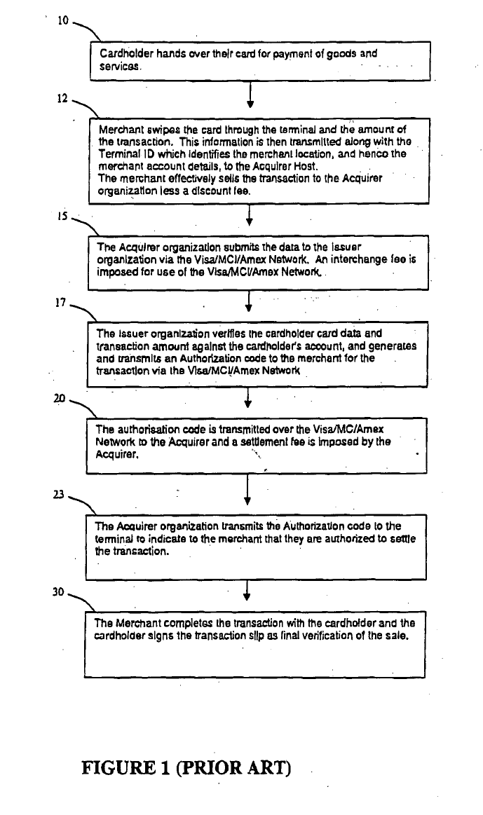

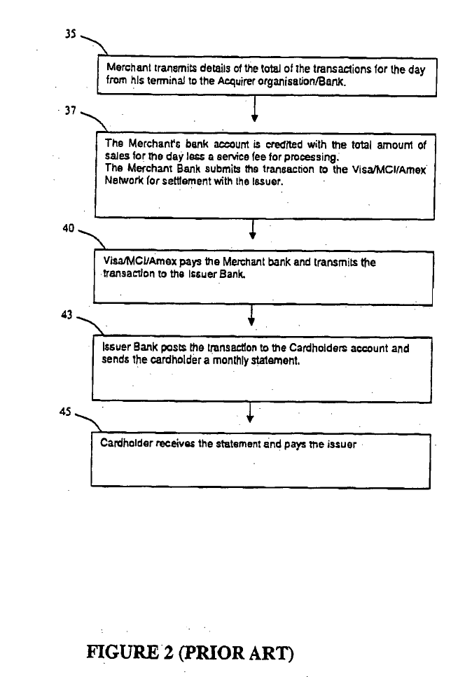

With references to FIGS. 1 and 2, the flow charts detail the primary method steps that are presently effected in POS networks in order to process cardholder transactions with merchants and to clear and settle those transactions between the various parties involved.

In particular, at the commencement of the process of effecting a transaction, at step 10 a cardholder hands their card to a merchant for payment of goods and/or services. As identified at step 12, the merchant swipes the card through the POS terminal and enters the amount of the transaction. Presently, merchants usually adopt a policy of refusing to process transactions that are not financially viable for the merchant to process. The amount below which a transaction is not financially viable for a merchant to process will vary from merchant to merchant and country to country. In any event, the amount of the transaction is then transmitted to a processing intermediary such as an Acquirer Host along with the Terminal ID which identifies the merchant location and the merchant account details.

At step 15, the Acquirer organisation receives the transmission from the merchant and in turn submits the transaction details to the organisation that issued the cardholder's card via an established network such as the Visa/MCI/Amex network. At steps 17 and 20, the issuing organisation verifies the card holder data and transaction amount against the cardholder's account and generates and transmits an authorisation code via the Visa/MCI/Amex network to the merchant. Transmission of the authorisation code from the Acquirer organisation to the merchant terminal is identified at step 23 and as a result of receiving an authorisation code, the merchant is effectively authorised to settle the transaction with the cardholder.

At step 30, the merchant completes the transaction with the cardholder and the cardholder signs the transaction slip as final verification of the sale of goods and/or services from the merchant to the cardholder.

With reference to FIG. 2, a flowchart detailing the primary method steps that are currently effected for the purpose of clearing and settling the transaction between the various parties as a result of a cardholder purchasing goods and/or services from a merchant. At step 35, the merchant transmits details pertaining to the total number and value of transactions for the day from the merchant's terminal to the Acquirer organisation and/or bank. At step 37, the merchant's bank account is credited with the total value of the merchants sales for the day with a service fee imposed for processing services. Step 37 also includes the merchant's bank submitting this particular transaction to an established network such as the Visa/MCI/Amex network for settlement with the issuer of the cardholder's card.

At step 40, the relevant card network “eg Visa/MCI/Amex” pays the merchant bank and transmits these transactions to the issuer's bank, The issuers bank posts the transaction to the cardholder's account, as detailed in step 43, and the cardholder receives a monthly statement from the issuer requesting payment as detailed at step 45.

The method steps effected in the flowcharts of FIGS. 1 and 2 have been in effect for many years and provide the basis for a reliable and efficient process for cardholders to purchase goods and/or services from merchants without the requirement for the cardholding consumer to carry and provide cash to a merchant for the purchase of goods and/or services.

However, as previously indicated, the POS network is a large and extensive network and whilst it may reliably and efficiently effect actions that are now considered to be well accepted by consumers, it is presently only possible to effect a limited set of actions by use of a POS network despite a clear desire on the part of merchants and other processing entities to provide an increased range of actions. Again, as previously indicated, an increase to the currently limited set of actions able to be effected by a POS network would ordinarily require a substantial expenditure by various entities to upgrade the servers and associated apparatus at POS access points and the software used to operate the POS system. However, according to one particular embodiment of the present invention, ancillary actions may be requested and effected by entering data at a POS network access point whereby that data indicates a predetermined ancillary action that is additional to the presently accepted set of actions that may be effected by a POS network.

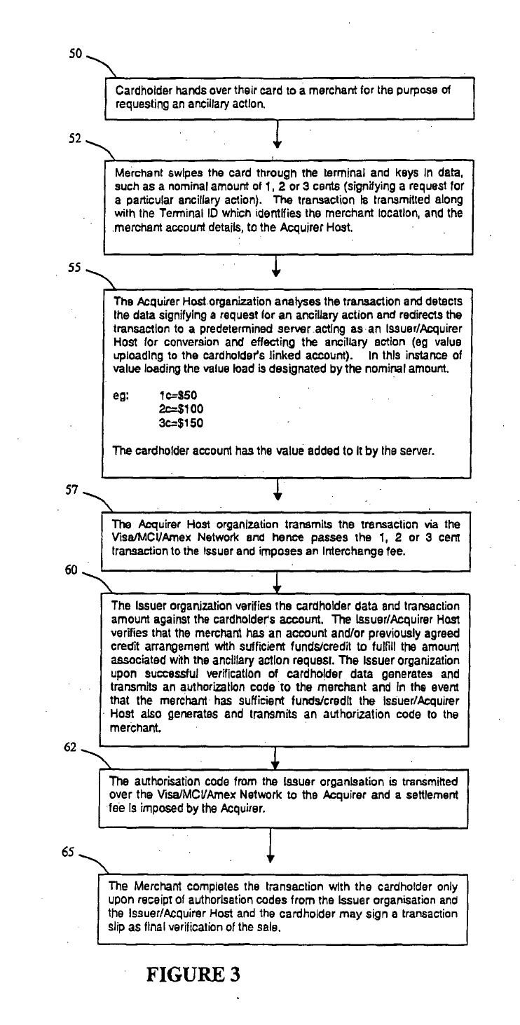

FIG. 3 is a flowchart detailing the primary method steps that are effected in a particularly preferred embodiment of the present invention that enables a cardholder to request an ancillary action and have same effected. At step 50, the cardholder provides their card to a merchant for the purpose of requesting an ancillary action over the POS network. As usual, the merchant receives the cardholder card and effects the same actions that would normally occur for a currently accepted action over the POS network. In the particular example of FIG. 3, the merchant swipes the card through the terminal thus enabling the terminal to extract the cardholder details from the card. However, in this instance at step 52, the merchant keys in data such as a nominal transaction value wherein the nominal transaction value signifies a request for a particular ancillary action that is identified by the cardholder to the merchant. Upon receiving the request from the cardholder for the ancillary action, the merchant keys in the relevant transaction value that corresponds to the particular ancillary action requested and the transaction is transmitted along with the Terminal ID identifying the merchant location and the merchant account details to the Acquirer Host.

At step 55, the Acquirer Host organisation receives the transaction from the merchant and analyses same to detect the inclusion of any data signifying a request for an ancillary action. Upon identifying such a request, the Acquirer Host redirects the transaction to a predetermined server acting as an Issuer Host. The Issuer Host correlates the data included in the transaction with a pre-recorded set of data values and the corresponding ancillary action and effects the ancillary action that has been requested in the transaction. In the event that the ancillary action is a request to increase the value of a cardholder's account, the value by which the cardholder's account is to be increased may be indicated by the transaction value. For example, a one cent transaction may correspond to a fifty dollar increase in a cardholder's account, a two cent transaction may equate to a one hundred dollar increase etc. Of course, in this particular example, the merchant would have already received the necessary funds equating to the value by which a cardholder required their account to be increased. In any event, at step 55, the cardholder account has the appropriate value added to it by the server.

At step 57, the Acquirer Host organisation transmits the transaction received from the merchant via the Visa/MCI/Amex network thus passing the transaction with the nominal transaction value to the issuer.

As the format of a POS packet is no different than the format of POS packets currently used to effect the current actions available over the POS network, the POS packet contained in the transmission from a merchant requesting an ancillary action will not cause any processing problems as it is processed by apparatus and devices that are presently processing POS transactions. In this regard, the transaction requesting an ancillary action is passed to the Issuer organisation that verifies the cardholder data and transaction amount against the cardholder's account. Of course, given that the transaction amount is a nominal value, it is not expected that the amount would cause a cardholder to exceed their credit limit as a result of processing the nominal transaction amount. As currently occurs, the Issuer organisation will then generate and transmit an authorisation code to the merchant and although the merchant will receive the authorisation code at step 62, whereas this authorisation code would normally allow the merchant to settle the transaction, in the particular instance of requesting an ancillary action, the merchant would effectively ignore the receipt of an authorisation code.

At step 65, the merchant has effectively completed the transaction with the knowledge that the POS transaction was transmitted to the Issuer and an authorisation code was generated and transmitted thus indicating that at least, the cardholder did not exceed their credit limit.

In a particularly preferred embodiment where transaction values of less than ten dollars are not usually effected by merchants, a nominal transaction value of an amount less than ten dollars is used for the purpose of signifying and identifying ancillary actions.

In another embodiment, a combination of the transaction value and the BIN of the customers/purchasers card is used to effect an ancillary action.

Preferred embodiments of the invention are described below detailing embodiments that enable a POS network to perform ancillary actions. In this respect, ancillary actions are those actions not currently implemented by presently installed software and apparatus of existing POS networks.

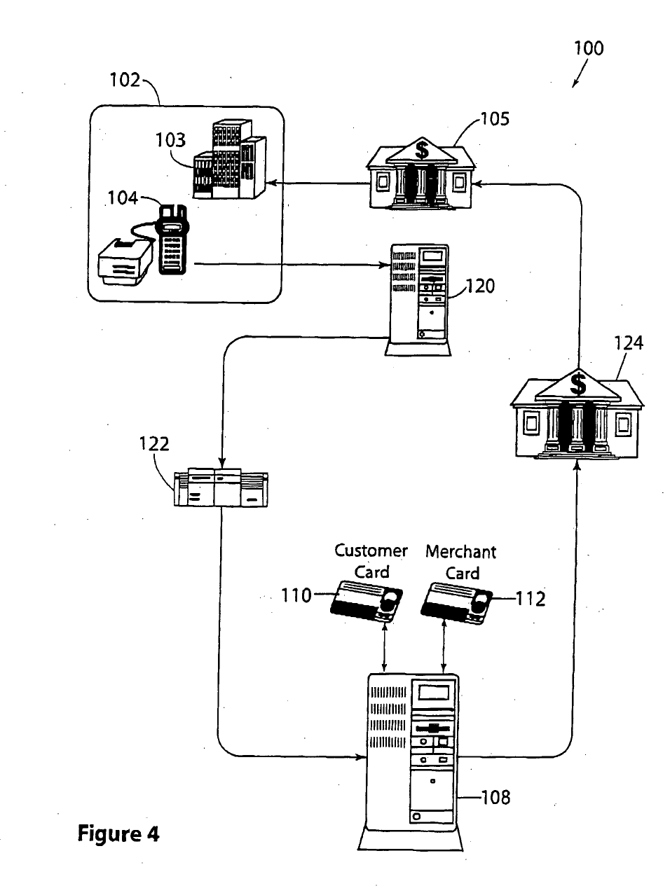

With reference to FIG. 4 there is shown a system 100 including POS access point 102 at merchant 103, a transaction acquiring server 122 such as VISA, Mastercard etc, card transaction acquiring processor 120, authorisation server 108, issuing bank 124 and the merchant or acquiring organisation 105. Access point 102 includes card reader 104 for reading either a magnetic strip or a barcode of a user device. It will be appreciated that any other suitable reader may be used for reading and transmitting user and account information stored on a storage device to authorisation server 108. Authorisation server 108 holds a ‘virtual account’ whereby data relating to a particular consumer is stored. Issuing bank 124 hosts the actual account for settlement of the transactions processed by authorisation server 108.

A user device in the form of a customer card 110, may use system 100 to effect ancillary actions that affect the details of the account stored on authorisation server 108, the account being associated with card 110. To effect a typical POS transaction, customer card 110 is read by card reader 104 at POS access point 102. Card reader 104 collects information relating to the account associated with the customer card 110 which is transmitted to the transaction acquiring processor 120 which subsequently forwards same to the card transaction acquiring server 122 and authorisation server 108 to determine the validity of the customer card 110. At this stage, the customer enters data relating to the transaction value and then selects the account type from which the amount of the transaction value should be debited. Of course, in the event that a customer is returning goods and seeks to reverse a previous purchase authorisation, the account type relating to the previous transaction would be credited.

Upon entering a transaction of value and the account type, details relating to the requested transaction are transmitted in a POS packet to the transaction acquiring server 122 and subsequently to the authorisation server 108 and the issuing bank 124 in order to obtain authorisation for the transaction based upon the current credit available in the customer's account. At this point, authorisation numbers and/or codes are provided representing approval for the transaction request and upon transmission of same to the merchant 103, the transaction is effectively complete.

To effect an ancillary action, customer card 110 is read by card reader 104 at POS access point 102 Card reader 104 collects information relating to the account associated with the customer card and transmits the information to transaction acquiring server 122 and subsequently to the authorisation server 108 for verification. Data representing a predetermined ancillary action is also entered at POS access point 102 and transmitted within a POS packet to the authorisation server 108. If the information relating to the customer card and the account is verified, then the authorisation server 108 analyses the POS packet received from the POS access point 102 to locate any data representing a request for a predetermined ancillary action. In one embodiment, the POS packet received at the transaction acquiring server 122 continues on to the card issuing entity such that the POS transaction, albeit requesting an ancillary action, is treated like any other POS transaction and continues to be transmitted to the card issuing entity. In this particular embodiment, the transaction acquiring server 122 effectively transmits a replica of the POS packet received from the POS access point 102 to the authorisation server 108 for processing of the request for an ancillary action. Authorisation server 108 executes computer instruction code that receives the POS packet and identifies the particular ancillary action requested by analysing the data embedded within the POS packet.

Of course, a consistent understanding on the part of a merchant with respect to the data entered at the POS access point 102 and the precise ancillary action that will be effected by the entry of that data is important. However, once merchants are advised of the data that may be used as part of a POS transaction and the ancillary action that will be effected as a result of the entry of specific data, merchants will be able to provide the additional services afforded by the ancillary actions to their customers.

In one embodiment, all merchants in possession of the relevant terminal equipment to provide a POS access point 102 are provided with details pertaining to the data that may be included in a POS transaction request and the ancillary actions that will be effected as a result of the entry of that data. In this particular embodiment, the environment may be considered to be effectively “open” such that any merchant and/or device currently connected to the POS network may be used by a cardholder and for example, having increased the value of an account, the cardholder may subsequently redeem values from that account in the form of cash from an automated cash dispensing device.

However, in another embodiment, the ability to effect ancillary actions over a POS network are only provided to a limited or restricted set of merchants who are advised of the details of the data entries required to effect those ancillary actions. Creating a limited set of merchants able to effect ancillary actions, or certain types of ancillary actions, effectively creates a “closed” environment that provides a range of advantages. In particular, to become a member of the restricted set of merchants able to effect ancillary actions, or certain types of ancillary actions, it is possible to require merchants to enter into agreements that may address a range of issues such as liability or dispute resolution in order for the merchant to be able to avail themselves of the ability to service customers by providing the ancillary actions.

At the end of each day, transactions that have been processed by authorisation server 108 are settled by issuing bank 124 to the merchant acquiring bank processor 105. The merchant acquiring bank 105, then settles the daily transactions with each individual merchant, including any monetary amount defined in the ancillary actions.

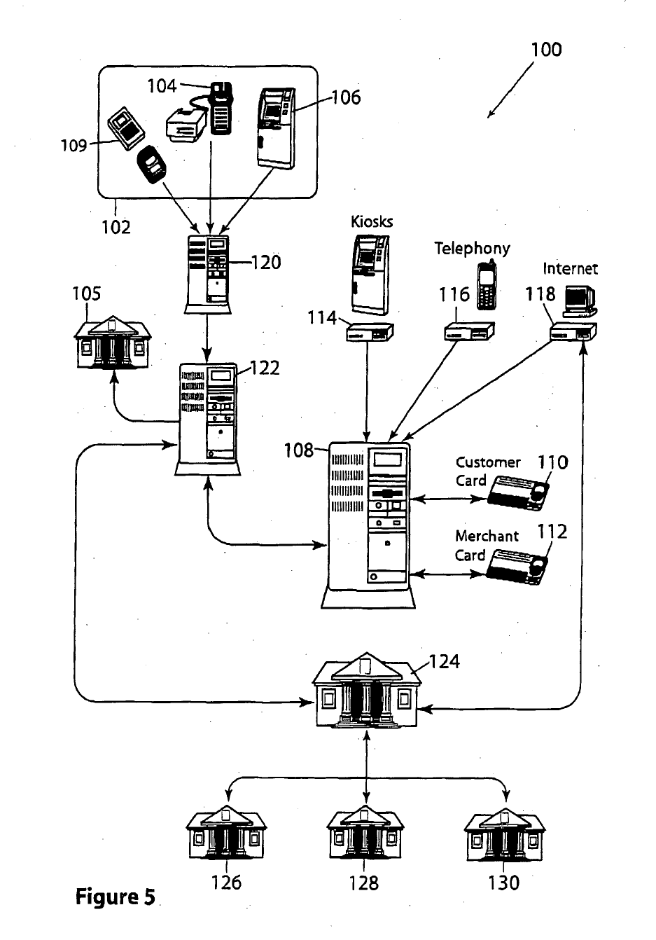

FIG. 5 provides another diagrammatic representation of a POS network but providing additional detail in relation to POS access points. Where the same features in FIG. 4 appear in FIG. 5, the same identification numbers are used. System 100 includes POS access point 102 that includes a magnetic strip card reader 104, a keypad 109 and an automatic teller machine (ATM) 106. The card reader 102 and ATM 106 are typical of the numerous electronic funds access points available in a wide range of locations such as supermarkets, department stores and service stations, which allow consumers 24 hour access to transfer and withdraw funds and/or use funds residing in an account to purchase goods or services from a merchant. It will also be appreciated that POS access point 102 could also include a barcode reader or any other suitable device to “read” information stored on any suitable user device.

System 100 also includes non-bank service providers, such as a kiosk 114 for the payment of bills or other invoices, telephony exchange 116 for placing telephone calls or updating a mobile or cell phone accounts, or an internet service provider 118.

In order for a user to perform an ancillary action via a POS network, customer card 110 is inserted into card reader 104 to collect account information associated with the user. The account information stored on the magnetic strip, or in an alternative embodiment a bar code, is transmitted to authorisation server 108 via the transaction acquiring server 122. The account information is verified at authorisation server 108 by comparing the stored data with data held on authorisation server 108. Data representing a predetermined ancillary action is entered at the access point 102, by a merchant, and upon identification by the transaction acquiring server 122, transmitted to authorisation server 108. When authorisation server 108 confirms that customer card 110 is associated with a valid account, the ancillary action is effected.

In one embodiment, customer card 110 may be issued by a card governing body such as VISA. If the card is issued by a governing body, it is usual that the governing body will require that the card be authenticated as part of the normal processing procedure. This may be performed by transaction acquiring server 122 which authenticates that customer card 110 is a card having a valid number, and possibly verify that the customer card 110 has not expired.

For example, in the case of effecting an ancillary action that adds value to an account, a user would swipe their customer card 110 through the magnetic card reader 104, and account information is transferred to authorisation server 108. Data representing a required ancillary action, such as a monetary value, is also entered at the POS access point 102 and passed to the authorisation server 108 for validation. If the account information is valid, then the value of the account is increased.

In a first embodiment, the amount by which an account is to be credited is stored at host level for that customer account. Therefore, in every instance where customer card 110 is used to increase the value of the account, the amount would always be the same, for example $20.00.

Of course, prior to concluding this transaction, a merchant providing access to a POS access point would ensure that they receive funds to cover the amount by which the value of the account is to be increased along with any amount corresponding to the monetary value that signifies and identifies the ancillary action. Further, in the instance of crediting an account, it is expected that merchants will collect funds in excess of the amount to be credited to a user's account in order to cover the additional costs associated with providing the services corresponding to the ancillary actions. There may be an additional fee payable to the merchant to cover the services of the merchant. This fee may be imposed as either a surcharge or a fee debited from the value credited to the card as determined by the ancillary action.

In a second embodiment, a merchant carrying a merchant card 112 would effect the transaction at the POS access point 102 either by a cash register (not shown) or similar device connected to the POS network or by card reader 104, in this instance, customer card 110 is inserted into card reader 104, and the details are verified by authorisation server 108 as previously mentioned. Data, such as a monetary value, would be entered at the POS access point 102 either through the cash register or keypad 109 of card reader 104 and if valid, the POS transaction is sent to the authorisation server 108. If the ancillary action is verified a success response is transmitted back to the terminal. Upon receiving the successful response at the terminal the Merchant then enters their merchant card 112 into the card reader 104. The merchant may have a selection of cards with each card representing a different amount such as $10.00, $20.00, $30.00 or $50.00 for increasing the value of the account. After the merchant swipes the card corresponding to the amount the user wishes to add to their card, the action of increasing the value of the account by that amount is effected due to the authorisation server 108 receiving two contiguous transactions from the same terminal, one representing the customer identifier and ancillary action request and the second being the amount agreed by the Merchant to increase the value of the customer's account.

A third embodiment enables a user to add any whole dollar amount to their account. Again, customer card 110 is inserted into card reader 104, when prompted for the customers PIN the Merchant enters the amount required for the ancillary action, The information is transmitted to transaction acquiring server 122 and the authorisation server 108 for verification. Data representing a request for an ancillary action such as a monetary value is extracted from the PIN field and added to the customers account, For example, a PIN of 0030 corresponds to a $30.00 increase to the customer's account.

Alternatively, the PIN may correspond to a dollar amount that is in excess of the amount that will be credited to a customer's account with the difference being to cover costs associated with providing the service of ancillary actions to a customer.

In preferred embodiments, the monetary amount corresponding to any ancillary action is collected from a Merchant either from a pre-funded merchant account (ie an account with a positive balance preferably maintained above a threshold value) or some other previously agreed commercial arrangement such as a direct debit facility.

Where the merchant has a pre-funded account, the balance of this account is preferably stored in authorisation server 108. When an ancillary action is requested of the authorisation server 108 that requires crediting a customer's account, the merchants account is debited by the required amount first. If this fails due to the prefunded merchant account not having sufficient funds to cover the transaction, a failed transaction response is returned to the terminal. In embodiments that include a merchant arrangement such as a prefunded merchant account or direct debit facility, the process of effecting an ancillary action requires the ancillary action request to be authorised (ie merchant requires sufficient funds/credit) prior to the merchant completing the transaction. Other ancillary actions may be performed at POS access point 102 such as activating and deactivating an account. Activating an account also requires customer card 110 to be read at the POS access point by card reader 104. Again, the account is verified by comparing information stored at authorisation server 108 with the information stored on the magnetic strip of card 110, and may additionally be secured by the user entering a personal identification number using keypad 109. Data representing a request for a particular ancillary action, such as a monetary value is entered at the POS access point 102 and transmitted to transaction acquiring server 122 and subsequently to authorisation server 108. Authorisation server 108 activates the account to allow card 110 to be used to add value to the account held on authorisation server 108 so that card 110 may be used as a normal POS card. Account deactivation may occur in a similar manner, however, in this case, an alternative monetary value is used to signify this particular ancillary action. Account deactivation may be used to temporarily suspend the use of a customer card 110 or to close an account.

Once a card has been activated, a customer selected PIN selected and the account carries a balance greater than zero, customer card 110 may be used to withdraw cash from ATM 106 (when implemented in an “open” environment) or may be used to transfer funds at any other POS access point 104. Further, customer card 110 may be used for non-bank service providers. Non-bank service providers may include kiosk 114, telephony/SMS/MMS switch/ exchange 116 or internet cafes or service providers 118. Kiosks 114 are typically used for the payment of bills. In this case the kiosk includes its own card reader such as a barcode reader or magnetic strip reader, and the information is transmitted from the kiosk 114 to authorisation server 108 for verification. The bill payment transaction is carried out in the usual manner by the user identifying the bill either by selecting the service provider or scanning a barcode printed on the bill and identifying the amount that they wish to pay. A receipt is then issued to verify proof of bill payments.

Customer card 110 may also be used to place telephone calls. In this instance, the user dials a nominated telephony service provider 116, and either quotes or dials the number on their card. The user then places their call in the normal manner and the cost of the call, plus in some cases a service fee, is deducted from the account balance held on authorisation server 108 by the telephony service provider. This is particularly advantageous as the user is not required to carry cash or establish an account with a particular telephony service provider. Further, the account balance associated with the card may be used to purchase additional time for use on a mobile telephone or cell phone. In this case, the account balance is transferred from the account held on authorisation server 108 associated with card 110 to the user's mobile phone.

Another non-bank service provider may be an internet provider or internet café 118. In the case of an internet cafe 118 the internet café authenticates and passes a transaction value from the café 118 to authorisation server 108 to verify customer card 110 which is to be used to access the internet. The internet access fees are then deducted from the account associated with card 110, and the user is able to access the internet.

Authorisation server 108 holds a “virtual” account and is connected to an issuing or cardholding bank, At the end of each day authorisation server 108 reports the daily transactions to the bank 124 and settlement occurs with the merchant's bank 125, and any account issuing organisations 126, 128 and 130. Daily settlement may also involve the payment of fees to the various merchants and institutions used to both increase the value of accounts and provide non-banking services. In this instance, for a user to increase the balance of their account held on authorisation server 108 by $20.00, the actual payment to the merchant may be $22.00. The extra $2.00 includes payment to the merchant of the monetary value, (for example one, two or three cents) along with a fee and also may include a fee payable to the account administrator, or the administrator of authorisation server 108.

### CONCLUSION

The present invention embodies many advantages and in particular, enables POS network service providers to increase the range of services available to users without the usual costs associated with upgrading and/or altering any of the network components currently installed at merchant locations or merchants banks that are usually involved in standard POS transactions; Additional services may be provided by a POS network effecting ancillary actions that-are communicated between network components by use of data such as monetary values or data fields that are not normally used in current POS transactions.

Additional services such as crediting an account have clearly been recognised as advantageous to consumers for quite some time. However, the impediment of upgrading and/or altering existing network components is a particularly significant impediment in view of the extent to which POS access points and network components have been distributed throughout geographic regions, Whilst the availability of POS access points has led to the remarkable success of encouraging users to avail themselves of the services provided by these networks, the proliferation of POS local access points and the network components supporting the services provided has also led to an unwieldy system in relation to performing upgrades and/or maintenance, Although it is clearly recognised that additional services currently not supported by an existing POS network would be beneficial to consumers, the substantial cost associated with upgrading existing POS network installations to provide those services is considered too costly to justify the likelihood of increased revenue as a result of providing the additional services to consumers.

The present invention avoids the significant cost impediment of upgrading existing POS networks and as such, additional services may be provided whilst avoiding the significant disadvantage of the cost associated with upgrading and/or altering network components in the usual manner.

Providing additional services such as crediting an account is a particularly advantageous service for consumers as it enables them to add value to an account associated with a standard POS customer card and subsequently use that standard card to purchase goods and/or services from merchants equipped with standard POS access equipment.

Many other additional services may be provided over time for implementation by the standard POS network as market needs are identified and these additional services may also be implemented without the usual cost impediment associated with upgrading and/or altering POS network components in the usual manner.

It will be appreciated by persons skilled in the relevant field of technology that numerous variations and/or modifications may be made to the invention as shown in the specific embodiments without departing from the spirit or scope of the invention as broadly described. The present embodiments are, therefore, to be considered in all respects as illustrative and not restrictive.

The claims defining the invention are as follows:

1. A POS network including:
account information collection means at a POS access point for collecting account information associated with a user;
verifying means for verifying said account information;
a data entry means at the POS access point for entering data that represents a predetermined ancillary action; and
transmission means for transmitting the data to a transaction processor that effects ancillary actions with respect to verified accounts in accordance with the ancillary action corresponding to the data transmitted.

2. A POS network when used for effecting ancillary actions, said POS network executing the following method steps:
collecting account information associated with a user at a POS access point;
verifying said account information;
transmitting data from the POS access point to a transaction processor said data representing a predetermined ancillary action; and
the transaction processor effecting said ancillary action with respect to the verified account.

3. A POS network according to claim 1 wherein said account information collection means is a magnetic strip reader operable to collect account information from a magnetic strip and said data entry means is a keypad operably connected to an POS terminal.

4. A POS network according to claim 1 wherein said account information collection means is any one or more of the following:
a barcode;
an radio frequency identification device;
a smart card;
a biometric card;
a mobile phone; or
a personal digital assistant.

5. An POS network according to claim 3 wherein said verifying means is an electronic processing device operably connected to the POS network and operable to receive a request from a merchant's POS access point for verification of a user and the associated account information collected from a user's device.

6. A POS network according to claim 5 wherein the data entry means is operable to receive data representing a predetermined ancillary action and the transmission means is an electronic processing device contained within a merchant terminal, the electronic processing device operable to transmit data entered by a user and/or merchant to a transaction processor connected to the POS network and operable to effect actions with respect to verified accounts by virtue of the transaction processor having access to information pertaining to those accounts.

7. A POS network according to claim 1 wherein the data representing a predetermined ancillary action is a monetary value that is typically unused in transactions across POS networks.

8. A POS network according to claim 1 wherein said data representing a predetermined ancillary action is data that resides within a data field of an POS packet said data field being typically unused in POS transactions.

9. A POS network according to claim 1 wherein only a predefined set of merchants are able to effect ancillary actions and hence provide the service associated with those ancillary actions to customers.

10. A method of operating a POS network to perform ancillary actions, the method including the steps of:
collecting account information associated with a user at an POS network access point;
verifying said account information;
entering data at the POS network access point that has a predetermined ancillary action associated with that data;
transmitting a POS packet from the network access point to a processing intermediary with the data representing the ancillary action embedded within said packet;
the processing intermediary receiving said POS packet, identifying said data and causing a transmission to a predetermined server for effecting said ancillary action; and
the predetermined server effecting said ancillary action with respect to the verified account.

11. A method according to claim 10 wherein the data representing a predetermined ancillary action is a monetary value that is typically unused in transactions across POS networks.

12. A method according to claim 10 wherein said data representing a predetermined ancillary action is data that resides within a data field of a POS packet said data field being typically unused in POS transactions.

13. A method according to claim 10 wherein subsequent to receiving said POS packet, the processing intermediary causes transmission of the POS packet to its originally intended destination in addition to causing a transmission of the POS packet to a predetermined server for effecting said ancillary action.

14. A method according to claim 10 wherein the processing intermediary subsequent to receiving said POS packet and identifying data representative of a request for an ancillary action causes the POS packet to be redirected to a predetermined server thus avoiding transmission of the POS packet to its originally intended destination.

15. A method according to claim 10 wherein only a predefined set of merchants are able to effect ancillary actions and hence provide the services associated with those ancillary actions to customers.

16. A method according to claim 10 wherein account information associated with a user is collected from a user device the user device only being operable to request ancillary actions.

17. A method according to claim 16 wherein the user device is a magnetic swipe card and a BIN is used to identify to a merchant terminal that the user device is only operable to request ancillary actions.

18. A method according to claim 10 wherein any requested ancillary action requires approval to ensure that a merchant has sufficient funds or credit to fulfil any monetary amount requested in a particular ancillary action request, the method only effecting an ancillary action after successfully performing the step of:
the predetermined server accessing a merchant account to verify that a merchant account has sufficient funds and/or credit required to fulfil the monetary amount associated with an ancillary action request; and
the requested ancillary action is only effected upon successful verification of sufficient funds and/or credit in the merchant account.

19. A method according to claim 18 including the step of:
the predetermined server causing transmission of a signal indicating verification of sufficient funds and/or credit in a merchant account and thus approval to the merchant to complete the transaction associated with the requested ancillary action.

20. A server which, in use, is operably connected to a POS network, said server including:
receiving means for receiving information relating to a user provided by a POS access point, said information including at least information identifying the user and an account associated with the user;
verifying means for verifying the information received;
a data receiving means for receiving data entered at the POS access point and a transmission means for transmitting said POS packet including the data that has a predetermined ancillary action associated with that data;
a comparison means to determine whether the POS packet received represents a request for a predetermined ancillary action; and
processing means for effecting said ancillary action with respect to the verified account, in the event that the received POS packet includes data representing a predetermined ancillary action.

21. A method according to claim 15 wherein upon presentation of a user device to a merchant terminal belonging to one of the predefined set of merchants, the BIN of the user device is determined by the merchant terminal and compared with the BIN's accepted by the merchant terminal and only in the event that the BIN of the user device corresponds with a BIN accepted by the predefined set of merchants is a request for an ancillary action transmitted from the merchant terminal.

22. A method according to claim 15 wherein upon a merchant belonging to the predefined set of merchants establishing that a valid user device has been submitted for the requesting of an ancillary action, a POS packet is transmitted from the network access point to a processing intermediary with the data representing the ancillary action embedded within said packet.

23. A method according to claim 20 wherein the processing intermediary upon receiving a POS packet from a merchant within the predefined set of merchants requesting an ancillary action, intercepts the POS packet and transmits same to a predetermined server for effecting the ancillary action.

24. A server which, in use, is operably connected to a POS network, said server including:
receiving means for receiving information relating to a user provided by a POS access point, said information including at least information identifying the user and an account associated with the user;
verifying means for verifying the information received;
a data receiving means for receiving data entered at the POS access point and a transmission means for transmitting said POS packet including the data that has a predetermined ancillary action associated with that data;
a comparison means to determine whether the POS packet received represents a request for a predetermined ancillary action; and
processing means for effecting said ancillary action with respect to the verified account, in the event that the received POS packet includes data representing a predetermined ancillary action.

25. A server according to claim 24 wherein the receiving means and the verifying means are electronic processing devices operably connected to the POS network and upon receipt of information including at least information identifying the user and an account associated with the user said information is passed to the verifying means that subsequently transmits a request over the POS network to another connected device that compares the user information and the account information for verification.

26. A server according to claim 24 wherein the data receiving means and the comparison means are electronic processing devices embodied within the server and operable to receive the data entered at the POS access point and form a comparison to determine whether that data represents a predetermined ancillary action respectively.

27. A server according to claim 24 wherein ancillary actions and their corresponding data values are stored in electronic memory within the server for interrogation by the comparison means.

28. A server according to claim 24 wherein the processing means is an electronic computing means operable to effect any valid ancillary action requested with respect to a verified account.

29. A computer program embodied on a computer readable medium for effecting ancillary actions with respect to a user's account, the computer program including:
computer instruction code for receiving account information associated with a user's account transmitted from a POS access point;
computer instruction code for verifying said account information;
computer instruction code for receiving a POS packet transmitted from the POS access point, said POS packet including data representing an ancillary action;
computer instruction code for determining whether any data received in the POS packet corresponds with a predetermined ancillary action; and
in the event that any data has an associated ancillary action, computer instruction code for effecting that ancillary action with respect to the verified account.

30. A method of effecting ancillary actions with respect to a user account including the steps of:
the user providing account information associated with the user at a POS access point and transmitting same across the POS network for verification;
entering data at the POS access point, said data representing an ancillary action to be performed on the user's account; and
receiving information transmitted across the POS network confirming whether said ancillary action has been effected with respect to the user's account.

31. A method of effecting ancillary actions with respect to a user's account including the steps of:
receiving account information associated with a user from a POS access point;
verifying said account information;
receiving data from said POS access point and determining whether the data represents an ancillary action; and
in the event that the data represents an ancillary action, effecting said ancillary action with respect to the verified account.
